(19) United States
(12) Patent Application Publication
(10) Pub. No.: US 2022/0335515 A1
(43) Pub. Date: Oct. 20, 2022

(54) DUAL LEDGER ARCHITECTURE FOR PHYSICAL AND VIRTUAL ACCOUNTS WITH A CONFIGURABLE INTEREST DISTRIBUTION SYSTEM

(71) Applicant: Goldman Sachs & Co. LLC, New York, NY (US)

(72) Inventors: Kunal Shah, Jersey City, NJ (US); Vadim Tsukhtman, Scarsdale, NY (US); Mohamed Ouaaddi, Brooklyn, NY (US); Anthony Daniel Carrozza, Brooklyn, NY (US)

(21) Appl. No.: 17/235,829

(22) Filed: Apr. 20, 2021

(51) Int. Cl. G06Q 40/02; G06F 16/248

(52) U.S. Cl. CPC G06Q 40/02; G06F 16/248

(57) ABSTRACT

A computer system includes an account data store, a physical account ledger, a virtual account ledger, and an interest distribution subsystem. The account data store includes the mappings between physical accounts and corresponding hierarchies of virtual accounts and interest distribution parameters indicating how interest is distributed between physical accounts and corresponding virtual accounts. The physical account ledger stores balances for the physical accounts and the virtual account ledger stores balances for the virtual accounts. The interest distribution subsystem is configured to receive interest accrual information from the ledgers and determine how to distribute the accrued interest according to the interest distribution parameters.

### BACKGROUND

### 1. Technical Field

The subject matter described relates generally to networked computing architectures and, in particular, to an architecture with dual ledgers for supporting physical accounts and corresponding hierarchies of virtual accounts and a configurable interest distribution system.

### 2. Background Information

Businesses and other entities often desire to have multiple bank accounts to segregate and track funds. For example, each division, project, or other subset of a business may have one or more bank accounts dedicated to specific functions, such as accounts receivable, expenses, payroll, equipment purchases, maintenance, or the like. Traditionally, entities have achieved this by having a large number of physical accounts with financial institutions. However, creating and maintaining these physical accounts can involve significant overhead in the form of costs, time paper-work. For example, opening a new physical account for a business can take several weeks.

To address this, many financial institutions now offer virtual accounts. A single physical account can be associated with multiple virtual accounts. If money is transferred between two virtual accounts that are associated with the same physical account, no funds transfer needs to occur between physical accounts. The financial institution simply updates the recorded balances for the virtual accounts accordingly. Furthermore, in some configurations, virtual accounts may be opened, configured, and closed by the account holder of the physical account using an interface (e.g., a self-service portal) without the need for extensive paperwork.

However, handling earned interest presents a challenge for existing computer-based virtual account management systems. For example, many existing systems lack a technical mechanism for determining how interest earned on the balance in an underlying physical account should be distributed among the associated virtual accounts. Similarly, if an interest rate is set on a virtual account, these existing systems do not provide a way to initiate a funds transfer for the corresponding amount to the underlying physical account. Such an approach inherently causes a mismatch between the balance on the physical account and the sum-total of the balance of all the child virtual accounts, which is not desirable.

### SUMMARY

The above and other problems are addressed by a computer system in which the tracking of physical and virtual account balances is separated from the determination of interest distribution. A physical account ledger tracks the balances of physical accounts and a virtual accounts ledger tracks the balances of virtual accounts. An interest distribution subsystem maintains an account data store that includes mappings between physical accounts and corresponding hierarchies of virtual accounts. The account data store also includes interest distribution parameters for the physical accounts (and corresponding hierarchies of virtual accounts) that can be selected by the account holders to provide different interest distribution schemes.

The interest distribution subsystem periodically distributes accrued interest among the physical and virtual accounts. In one embodiment, for each physical account, the interest distribution subsystem uses an identifier of the physical account to query the account data store for the corresponding hierarchy of virtual accounts. The interest distribution subsystem receives interest accrual information from the physical account ledger, the virtual account ledger, or both. The interest distribution subsystem retrieves the interest distribution parameters for the physical account and determines how to distribute the accrued interest using the interest accrual information and the interest distribution parameters. The physical and virtual account ledgers are updated by posting the determined amounts of interest to the physical and virtual accounts, respectively. The disclosed approach to interest distribution can provide parity between postings on virtual accounts and the corresponding physical accounts; allow for a balance and interest reconciliation between the physical and the virtual accounts; and provide flexibility to enable clients to use their preferred allocations of interest distribution to underlying virtual accounts.

### BRIEF DESCRIPTION OF THE DRAWINGS

FIG. 1 is a block diagram of a networked computing environment suitable for providing configurable interest distribution between physical and virtual accounts, according to one embodiment.

FIG. 2 is a block diagram illustrating one embodiment of the account management system of FIG. 1.

FIG. 3 illustrates a hierarchy of virtual accounts associated with a physical account, according to one embodiment.

FIG. 4 is a flowchart illustrating a method for distributing interest to a physical account and the corresponding hierarchy of virtual accounts, according to one embodiment.

FIG. 5 is a block diagram illustrating an example computer suitable for use in the networked computing environment of FIG. 1, according to one embodiment.

### DETAILED DESCRIPTION

Reference will now be made to several embodiments, examples of which are illustrated in the accompanying figures. Wherever practicable, similar or like reference numbers are used in the figures to indicate similar or like functionality. Where similar elements are identified by a reference number followed by a letter, a reference to the number alone in the description that follows may refer to all such elements, any one such element, or any combination of such elements. One skilled in the art will readily recognize from the following description that alternative embodiments of the structures and methods may be employed without departing from the principles described.

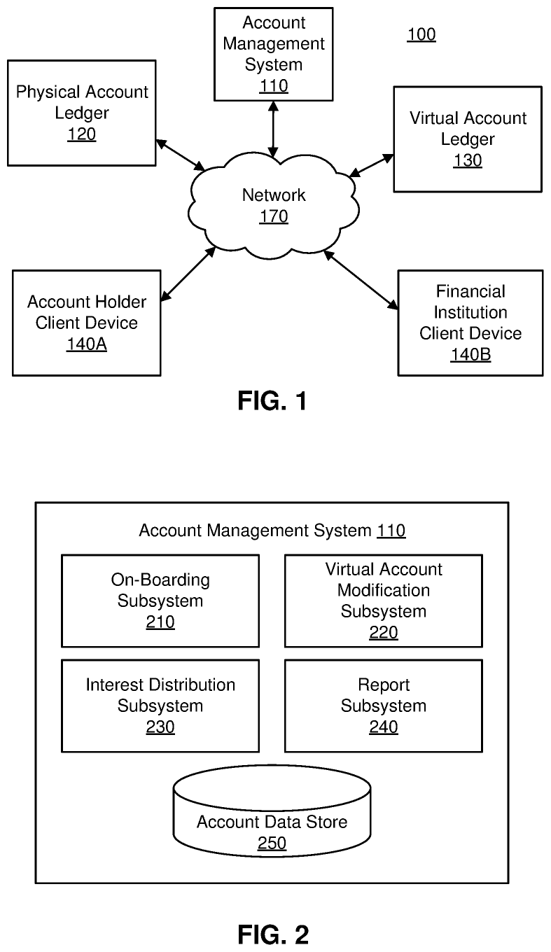

FIG. 1 illustrates one embodiment of a networked computing environment 100 suitable for providing configurable interest distribution between physical and virtual accounts. In the embodiment shown in FIG. 1, the networked computing environment 100 includes a n account management system 110, a physical account ledger 120, a virtual account ledger 130, an account holder client device 140A, and a financial institution client device 140B, all connected via a network 170. In other embodiments, the networked computing environment 100 contains different or additional elements. In addition, the functions may be distributed among the elements in a different manner than described. For example, the functionality of the account management system 110, physical account ledger 120, and virtual account ledger 130 may be provided by a single financial institution computing system. Furthermore, although the account management system 110 is shown as a single entity for convenience, the corresponding functionality may be provided by multiple networked computing devices.

The account management system 110 includes one or more computers configured to manage physical and virtual accounts for account holders. The account management system 110 may be provided by a financial institution such as a bank. The account management system 110 stores mappings between hierarchies of virtual accounts and the corresponding physical accounts. The account management system 110 periodically (e.g., daily, weekly, each business day, etc.) determines how to distribute interest among the physical and virtual accounts and post the determined amounts to the corresponding ledger. Alternatively, more complex schedules may be used for distributing interest. The account management system 110 may also provide functionality for the generation of reports regarding the balances and interest paid on selected physical or virtual accounts. Various embodiments of the account management system 110 are described in greater detail below, with reference to FIG. 2.

The physical account ledger 120 includes one or more computing devices that store balances and transaction information for physical accounts (e.g., on one or more computer-readable media). Each physical account has an account identifier such as an account number. A physical account's balance and transaction information is stored in association with its account identifier (e.g., in a database). In one embodiment, the physical account ledger 120 stores interest rates for the physical accounts and periodically (e.g., daily, weekly, each business day, etc.) calculates the amounts of interest accrued. Alternatively, the physical account ledger 120 may calculate the interest accrued using interest rates received from the account management system 110 or provide physical account balances to the account management system 110 so the account management system 110 can distribute the amounts of interest accrued. The account management system 110 may also apply tax withholdings to physical accounts or calculate fees, etc.

The virtual account ledger 130 is similar to the physical account ledger 120 except that it stores balances and transaction information for virtual accounts. Each virtual account has an account identifier such as an account number and the virtual account's balance and transaction information is stored in association with its account identifier. As with the physical account ledger 120, the virtual account ledger 130 may store interest rates for virtual accounts and periodically calculate the interest accrued, calculate the interest accrued using interest rates received from the account management system 110, or provide virtual account balances to the account management system 110 so the account management system 110 can distribute the amounts of interest accrued. The account management system 110 may also apply tax withholdings to virtual accounts or calculate fees derived from the accrued interest, etc.

The client devices 140 are computing devices with which users can interact with the account management system 110 (e.g., via the network 170). Example client devices 140 include desktop computers, laptops, smartphone, and tablets, etc. In one embodiment, the account holder client device 140A executes software with which an account holder can interact with the account management system 110 to request a new physical account, open new virtual accounts, define or update the relationships between virtual accounts in a hierarchy, choose an interest package and preferred allocations, view account balances, request and view reports on the account holder's accounts, and the like. The account holder client device 140A may access the functionality provided by the account management system 110 via a user portal (e.g., accessed using a web browser). Similarly, the financial institution client device 140B may execute software with which a representative (e.g., an employee) of the financial institution can interact with the account management system 110 to assist potential or existing account holders open new physical accounts, define interest packages, perform auditing or maintenance operations, generate reports, or the like. For example, the financial institution client device 140B may access the account management system 110 via a financial institution portal that provides different functionality than the user portal. Although only one account holder client device 140A and one financial institution client device 140B is shown in FIG. 1, the networked computing environment 100 can include any number of client devices 140 of each type at any given time. Furthermore, the same client device may operate as both an account holder client device 140A and a financial institution client device 140B at different times.

The network 170 may include any combination of local area and wide area networks employing wired or wireless communication links. In one embodiment, network 170 uses standard communications technologies and protocols. For example, network 130 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 130 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 170 may be represented using any format, such as hypertext markup language (HTML) or extensible markup language (XML). Some or all of the communication links of the network 170 may be encrypted.

FIG. 2 illustrates one embodiment of the account management system 110. In the embodiment shown, the account management system 110 includes an on-boarding subsystem 210, a virtual account modification subsystem 220, an interest distribution subsystem 230, a report subsystem 240, and an account data store 250. In other embodiments, the account management system 110 contains different or additional elements. In addition, the functions may be distributed among the elements in a different manner than described. For example, while the functionality of the interest distribution subsystem 230 and the report system 240 are described separately for clarity, a single system may perform the functions of both.

The on-boarding subsystem 210 provides an interface for the creation of new physical accounts by potential account holders. The on-boarding system may enable potential account holders to communicate either in real time or asynchronously with a representative of the financial institution to work through the account creation process. For example, the potential account holder may provide requested information about the business for which the account will be used to enable the representative of the financial institution to complete know your customer checks and any other verification required by the financial institution.

Assuming the creation of a new physical account is approved, the on-boarding subsystem 210 generates or otherwise obtains a new physical account identifier and stores it (e.g., in the account data store 250) in association with information about the account holder. The on-boarding subsystem 210 may also instruct the physical account ledger 120 to initialize a record set for the new physical account by providing the account identifier and an initial balance as well as any other appropriate information about the new physical account.

In various embodiments, the on-boarding subsystem 210 also creates an initial hierarchy of virtual accounts. The on-boarding system 210 may generate (or otherwise obtain) and store a virtual account identifier for each virtual account in the initial hierarchy and store (e.g., in the account data store 250) the virtual account identifier in association with an indication of the virtual accounts position in the initial hierarchy and the identifier of the underlying physical account. The on-boarding system may also instruct the virtual account ledger 130 to initialize records sets for the virtual accounts by providing the virtual account identifiers, initial balances, and any other appropriate information about the new virtual account. In one embodiment, the initial virtual account hierarchy includes a default virtual interest account, a default virtual fee account, and a default virtual suspense account. The default virtual interest is where any accrued interest for which a specific target virtual account is not specified is posted. The default virtual fee account is the default account from which fees paid by the account holder to the financial institution are taken if no other payment account is specified. The default virtual suspense account is a holding account where any payments that are ambiguous or otherwise need further investigation are posted pending resolution.

As part of the account creation process, the on-boarding subsystem 210 receives interest distribution parameters (e.g., via user input at an account holder client device 140A or a financial institution client device 140B) that indicate how accrued interest should be distributed. The on-boarding subsystem 210 stores the interest distribution parameters (e.g., in the account data store) in association with an identifier of the underlying physical account. Alternatively, the interest distribution parameters selected by an account holder can be stored in association with an identifier of the account holder (e.g., an account holder ID). Thus, if the account holder has multiple physical accounts, the same interest distribution parameters may be shared across all of the physical accounts. The interest distribution parameters can be customized for each physical account or each account holder to provide a range of different interest distribution schemes to suit the needs and preferences of the account holders. The on-boarding system 210 may also send information (e.g., copies of the relevant interest distribution parameters) to the physical account ledger 120 and the virtual account ledger 130 indicating how accrued interest should be calculated (if at all) for the physical and virtual accounts, respectively.

In some embodiments, the interest distribution parameters include a physical account posting method and a virtual account posting method. In one such embodiment, the account holder may select the physical account posting method from options including: default accrual; virtual account aggregated accrual; virtual account individual accrual; and partial physical account accrual.

Default accrual: The physical account accrues interest each period at an interest rate (e.g., a percentage of the account balance accrued each period) and the amount accrued is posted to the physical account ledger 120. The amount accrued by the physical account is also posted to the corresponding default virtual interest account on the virtual account ledger 130.
Virtual account aggregated accrual: Interest is accrued for each virtual account in the hierarchy at a virtual account interest rate. The virtual account interest rate may be the same for all virtual accounts or each virtual account (or type of virtual account) may have an individual interest rate. The interest accrued for the virtual accounts is aggregated and a single posting for the aggregated amount is made to the physical account ledger 120.
Virtual account individual accrual: Interest is accrued for each virtual account in the hierarchy at the corresponding virtual account interest rate. An individual posting is made to the physical account ledger 120 for the interest accrued by each virtual account.
Partial physical account accrual: The accrued interest is calculated for the physical account in the same manner as the default method and the amount accrued by virtual accounts is calculated in the same manner as if virtual account aggregated accrual was selected. The aggregate amount accrued by the virtual accounts is posted to the physical account ledger 120. The difference between the amount accrued by the virtual accounts and the amount accrued by the physical account is also posted to the physical account ledger on another physical account. This can be posted as interest or a fee based on the client preference.

In one embodiment, the account holder may select the virtual account posting method from options including: default utility account; default individual accounts; accrual report only; accrual from utility account; accrual from expense account; and allocation from utility account.

Default utility account: Interest accrual is not calculated for the virtual accounts. The amount of interest posted to the physical account is received by the virtual account ledger 130 as part of a replication process and the same amount is posted to a default virtual interest account. The account holder may then transfer money from the default virtual interest account as desired.
Default individual accounts: Interest accrual is not calculated for the virtual accounts. The amount of interest posted to the physical account is received by the virtual account ledger 130 as part of a replication process and distributed through postings to individual virtual accounts according to predetermined percentage allocations provided in advance by the account holder. The percentage allocations may be included in the distribution parameters or stored separately (e.g., in the account data store 250 or at the virtual account ledger 130).
Accrual report only: The accrual for each virtual account is calculated using its accrual rate but is not posted to the virtual account ledger 130. The calculated amounts may be stored and used to generate reports. For example, a report may show what interest a virtual account could have accrued and the account holder can decide whether to manually transfer some or all of the corresponding amount to the virtual account (e.g., from the default virtual interest account), transfer some or all of the corresponding amount to another account (e.g., to an investment account), or take any other action (including no action).
Accrual from utility account: The accrual for each virtual account is calculated using its accrual rate. The accrued interest is posted from the default virtual interest account to each individual virtual account for which interest accrued.
Accrual from expense account: The accrual for each virtual account is calculated using its accrual rate. The accrued interest is posted from one or more expense accounts of the financial institution providing the virtual accounts.
Allocation from utility account: The amount of interest posted to each virtual account is determined from a predetermined allocation (e.g., as stored in the account data store 250 or at the virtual account ledger 130). The determined amount of interest is posted to each virtual account from the default virtual interest account. For example, an amount corresponding to the interest accrued by the underlying physical account may be posted to the default virtual interest account and then distributed according to predetermined percentage allocations (e.g., the account holder's preferred allocations or a dynamic client allocation instructions feed) to each virtual account provided by the account holder.

As noted previously, the account holder may select which interest allocation methods to use for its physical and virtual accounts. In some embodiments, the financial institution providing the accounts may place limitations on which methods or combinations of methods may be selected. Furthermore, financial institutions may provide different or additional methods of allocation than those described above.

The virtual account modification subsystem 220 provides an interface for account holders to modify the virtual account hierarchy associated with their physical account (or accounts). In one embodiment, the virtual account modification subsystem 220 provides an account holder portal that can be accessed from an account holder client device 140A via the network 170 (e.g., using a web browser). Using the account holder portal, an account holder can create new virtual accounts, change the relationships between accounts in the hierarchy, initiate transfers between virtual accounts, and the like. In some embodiments, the account holder may also update the interest distribution parameters.

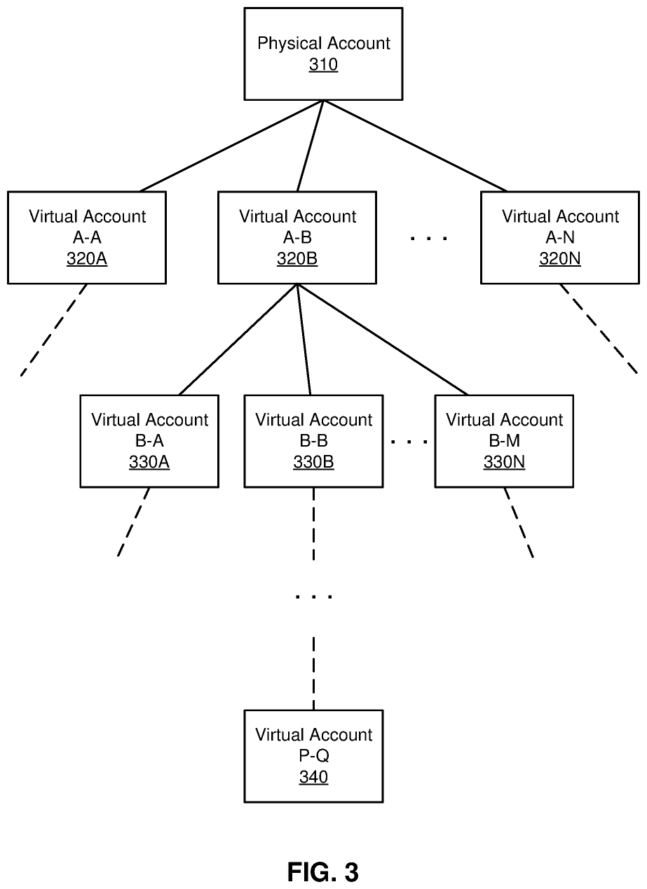

FIG. 3 illustrates an example hierarchy of virtual accounts associated with a physical account 310, according to one embodiment. The balance of the physical account 310 (e.g., as stored on the physical account ledger 120) should match the sum of the balances of all of the virtual accounts in the hierarchy. In the embodiment shown, the physical account is associated with a set of N virtual accounts 320 in a first level of the hierarchy. Although FIG. 3 shows three virtual accounts 320, any number of virtual accounts may be included in the first level of the hierarchy. The virtual accounts in the first level of the hierarchy may include the default virtual interest account, the default virtual fee account, and the default virtual suspense account.

There is also a set of M virtual accounts 330 in a second level of the hierarchy that are linked to virtual account A-B 320B in the first level of the hierarchy. Although FIG. 3 does not show any virtual accounts connected to virtual account A-A 320A or virtual account A-N 320N, the second level of the hierarchy may include any number of additional virtual accounts (including zero) associated with each virtual account 320 in the first level of the hierarchy. Each virtual account in the first level of the hierarchy may have a true balance (the actual balance of that virtual account) and a hierarchy balance (the sum of the virtual account's true balance and the true balances of each of the immediate child accounts in the hierarchy).

The hierarchy of virtual accounts can in principle have as many levels as the account holder desires. In the example shown in FIG. 3, the hierarchy has P levels, with level P including virtual account P-Q 340. As with the other levels of the hierarchy, level P may include any number of virtual accounts. To constrain memory and processing requirements, the financial institution may place a limit on the number of levels, such as twenty, fifty, or one hundred levels, but this limit can generally be set high enough that it is essentially unlimited for practical purposes.

Referring again to FIG. 2, in various embodiments, the account holder can use the virtual account modification subsystem 220 to add new virtual accounts to the hierarchy, remove unneeded virtual accounts from the hierarchy, and change the position of virtual accounts in the hierarchy. In one embodiment, the financial institution provides different types of virtual account that may be included in the hierarchy. The different types of virtual account may have different interest rates, minimum balances, fee structures, minimum and maximum transfer amounts, etc. Thus, the account holder can construct a hierarchy of virtual accounts to serve various needs.

The interest distribution subsystem 230 determines how to distribute accrued interest between the physical and virtual accounts. In one embodiment, the interest distribution subsystem 230 periodically receives the amounts of interest accrued for physical and virtual accounts from the physical account ledger 120 and the virtual account ledger 130, respectively. Depending on the interest distribution parameters for account holders, the interest distribution subsystem 230 may not receive accrued interest amounts for some of the physical and virtual accounts. For example, the physical account ledger 120 will not provide an accrual amount for a physical account that uses virtual account aggregated accrual or virtual account individual accrual. Similarly, the virtual account ledger 130 will not provide accrual amounts for virtual accounts that use the default utility account or default individual account methods. In another embodiment, the interest distribution subsystem 230 receives balance information for the physical and virtual accounts from the ledgers and calculates the accrued interest using the received balance information and interest rates for each account.

The interest distribution subsystem 230 retrieves the interest distribution parameters for accounts (e.g., from the account data store) and determines how much accrued interest to distribute to each account using the retrieved parameters. The interest distribution subsystem 230 posts the determined amounts of interest for physical accounts to the physical account ledger 120 and the determined amounts of interest for virtual accounts to the virtual account ledger 130.

The report subsystem 240 generates reports for the account holder regarding accrued and posted interest. In one embodiment, account holders can access the amounts of interest posted to each of their physical accounts in each period on demand through the account holder portal. To enable efficient generation of reports, the amounts of interest posted to accounts may be stored in the account data store 250. For example, even if an account holder does not want interest accrued by virtual accounts to be posted to the individual virtual accounts, the accrual report only parameter may be selected to enable the interest distribution subsystem 230 to receive an indication to not distribute the amount of interest each virtual account accrued. In other embodiments, the report subsystem 240 may generate reports in full or in part by retrieving information from the physical account ledger 120 and the virtual account ledger 130.

The account data store 250 includes one or more computer readable media configured to store account data used by the account management system 110, such as the associations between physical accounts and virtual accounts in a hierarchy and the interest distribution parameters selected for those accounts. Although the account data store is shown as part of the account management system 110, some or all of the account data may be stored remotely and accessed via the network 170. Furthermore, while the account data store 250 is shown as a single element, the account data may be split into multiple parts and stored across multiple devices (e.g., in a distributed database).

### Example Methods

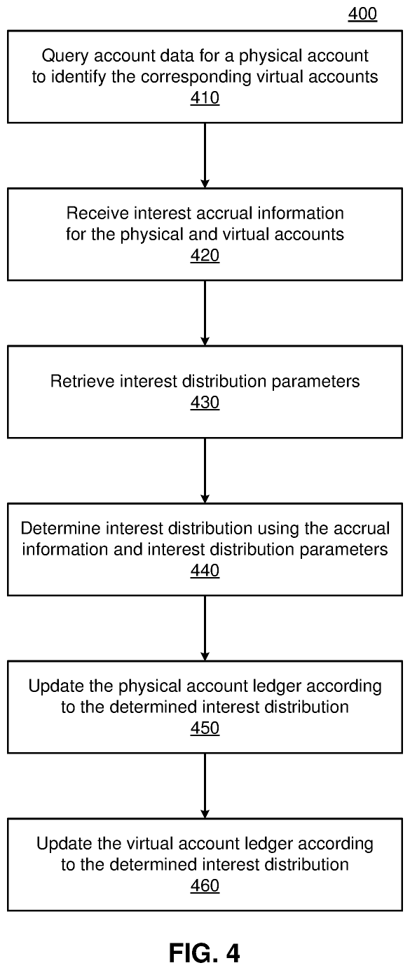

FIG. 4 illustrates an example method 400 for distributing interest to a physical account and the corresponding hierarchy of virtual accounts, according to one embodiment. The steps of FIG. 4 are illustrated from the perspective of the interest distribution subsystem 230 performing the method 400. However, some or all of the steps may be performed by other entities or components. In addition, some embodiments may perform the steps in parallel, perform the steps in different orders, or perform different steps. For example, although FIG. 4 shows the physical account ledger being updated before the virtual account ledger, in practice, the ledgers may be updated at the same time or in the reverse order.

The method 400 may be triggered as part of a periodic interest posting process. In one embodiment, the interest distribution subsystem 230 cycles through all of physical accounts it manages once each period (e.g., at the start or end of each day) and determine the interest distribution for each using the method 400. Alternatively, the physical account ledger 120 (or another component of the networked computing environment 100) may trigger the method 400 by sending an instruction to the interest distribution subsystem 230 to distribute interest for all or an identified subset of the accounts it manages. For example, the physical account ledger 120 may determine accrued interest for physical accounts once each period and trigger the method 400 by sending the amount of accrued interest for one or more physical accounts to the interest distribution subsystem 230.

In the embodiment shown in FIG. 4, the method 400 begins with the interest distribution subsystem 230 querying 410 account data (e.g., in the account data store 250) to identify the corresponding virtual accounts. The interest distribution subsystem 230 may use an identifier (e.g., an account number) of the physical account to query the account data and receive one or more virtual account identifiers of virtual accounts that correspond to the physical account. The query results may also indicate the hierarchical relationships between the identified virtual accounts.

The interest distribution subsystem 230 receives 420 interest accrual information for the physical account and the corresponding virtual accounts from the physical account ledger 120 and the virtual account ledger 130, respectively. The interest accrual information may be sent automatically to the interest distribution subsystem 230 each period or the interest distribution subsystem 230 may request the interest accrual information for each account from the appropriate ledger. As noted previously, in on embodiment, the method 400 is triggered by receiving 420 the physical account accrual information. In which case, the receiving step 420 need not be repeated.

The interest distribution subsystem 230 retrieves 430 the interest distribution parameters for the physical account (e.g., from the account data store 250). The interest distribution subsystem 230 determines 440 how to distribute the accrued interest using the accrual information for the physical and virtual accounts and the interest distribution parameters.

The interest distribution subsystem 230 updates 450 the physical account ledger 120 according to the determined interest distribution. For example, the interest distribution subsystem 230 may post the amount of interest determined to be distributed to the physical account to the physical account ledger 120. Similarly, the interest distribution subsystem 230 may update 460 the virtual account ledger by posting the amounts of interest determined to be distributed to each virtual account.

Using the method 400 with different interest distribution parameters provides account holders with greater control over the distribution of interest. By externalizing the task of determining interest distribution from the ledgers, account holders can be provided with flexibility in how interest is distributed to meet a wide range of business needs and preferences. For example, in one configuration, the virtual account aggregated accrual method is used for physical account interest distribution and the allocation from utility account method is used for virtual account interest distribution. In this configuration, the total amount of interest accrued is calculated by multiplying each virtual account by its interest rate and summing the results. The total amount of interest is posted to the physical account from an expense account of the financial institution. The total amount is also then posted to the corresponding default virtual interest account before being distributed to the individual virtual accounts according to the distribution specified by the account holder (e.g., as indicated in an interest distribution file stored in the account data store 250). This approach provides significant flexibility because the interest need not be distributed to the virtual accounts in the same proportion as it was accrued.

### Computing System Architecture

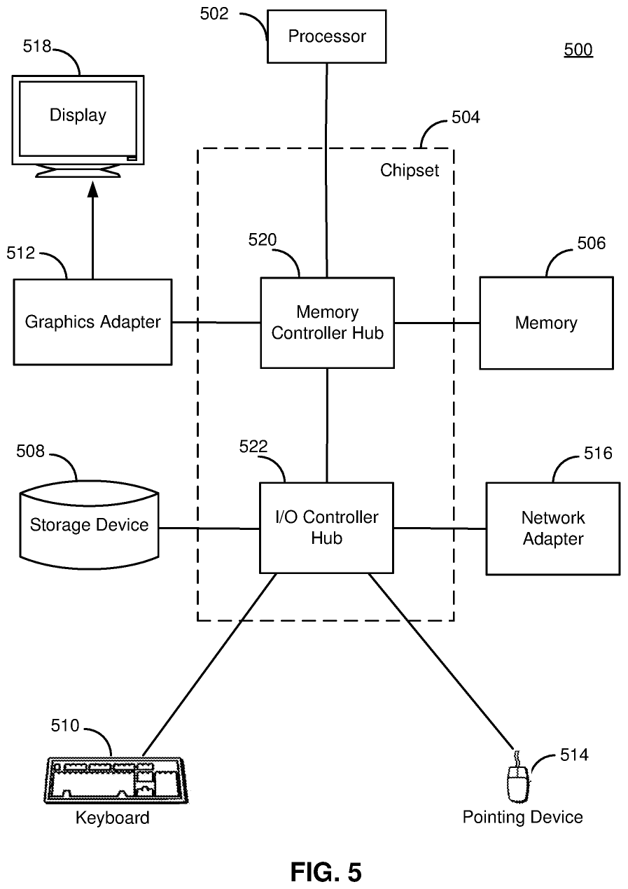

FIG. 5 is a block diagram illustrating an example computer 500 suitable for use as an account management system 110, physical account ledger 120, virtual account ledger 130, or client device 140. The example computer 500 includes at least one processor 502 coupled to a chipset 504. The chipset 504 includes a memory controller hub 520 and an input/output (I/O) controller hub 522. A memory 506 and a graphics adapter 512 are coupled to the memory controller hub 520, and a display 518 is coupled to the graphics adapter 512. A storage device 508, keyboard 510, pointing device 514, and network adapter 516 are coupled to the I/O controller hub 522. Other embodiments of the computer 500 have different architectures.

In the embodiment shown in FIG. 5, the storage device 508 is a non-transitory computer-readable storage medium such as a hard drive, compact disk read-only memory (CD-ROM), DVD, or a solid-state memory device. The memory 506 holds instructions and data used by the processor 502. The pointing device 514 is a mouse, track ball, touch-screen, or other type of pointing device, and is used in combination with the keyboard 510 (which may be an on-screen keyboard) to input data into the computer system 500. The graphics adapter 512 displays images and other information on the display 518. The network adapter 516 couples the computer system 500 to one or more computer networks (e.g., network 170).

The types of computers used by the entities of FIGS. 1 and 2 can vary depending upon the embodiment and the processing power required by the entity. For example, the server 110 might include a distributed database system comprising multiple blade servers working together to provide the functionality described. Furthermore, the computers can lack some of the components described above, such as keyboards 510, graphics adapters 512, and displays 518.

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the element or component is present unless it is obvious that it is meant otherwise.

Where values are described as “approximate” or “substantially” (or their derivatives), such values should be construed as accurate +/−10% unless another meaning is apparent from the context. From example, “approximately ten” should be understood to mean “in a range from nine to eleven.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

While particular embodiments and applications have been illustrated and described, it is to be understood that the described subject matter is not limited to the precise construction and components disclosed. The scope of protection should be limited only by any claims that ultimately issue.

What is claimed is:

1. A computer system comprising:
an account data store including one or more non-transitory computer-readable media configured to store account data, the account data including mappings between physical accounts and virtual accounts, and further including, for each physical account and the corresponding virtual accounts, interest distribution parameters indicating how interest is distributed between the physical account and the virtual accounts;
a physical account ledger including one or more non-transitory computer-readable media configured to store physical account data, the physical account data comprising balances for the physical accounts;
a virtual account ledger including one or more non-transitory computer-readable media configured to store virtual account data, the virtual account data comprising balances for the virtual accounts; and
an interest distribution subsystem configured to, for each physical account:
query the account data store, using an identifier of the physical account, to identify the corresponding virtual accounts;
receive, from at least one of the physical account ledger and the virtual account ledger, interest accrual information;
retrieve, from the account data store, the interest distribution parameters for the physical account and the corresponding virtual accounts;
determine, using the interest accrual information and interest distribution parameters, amounts of interest for the physical account and each virtual account corresponding to the physical account;
update the physical account ledger to reflect the determined amount of interest for the physical account; and
update the virtual account ledger to reflect, for each virtual account corresponding to the physical account, the determined amount of interest for that virtual account.

2. The computer system of claim 1, wherein the virtual accounts that correspond to a given physical account include a default virtual interest account, a default virtual fee account, and a default virtual suspense account.

3. The computer system of claim 1, wherein the virtual accounts that correspond to a given physical account are arranged in a hierarchy, the hierarchy including a first plurality of virtual accounts in a first level and a second plurality of virtual accounts in a second level.

4. The computer system of claim 3, wherein a balance of the given physical account equals a sum of balances of the virtual accounts that correspond to the given physical account.

5. The computer system of claim 1, wherein the interest distribution parameters for a given physical account include a first parameter and as second parameter, the first parameter indicating how interest is distributed to the given physical account and the second parameter indicating how interest is distributed to the virtual accounts corresponding to the given physical account.

6. The computer system of claim 1, wherein:
the interest accrual information includes an amount of interest accrued by a given physical account, and the physical account ledger is updated by posting the amount of interest accrued by the given physical account from an expense account of a financial institution to the physical account; and
the virtual account ledger is updated by determining, using a predetermined allocation, amounts to distribute to each of the virtual accounts corresponding to the given physical account, and posting the determined amounts from a default virtual interest account to the virtual accounts that correspond to the physical account.

7. The computer system of claim 6, wherein the amount of interest accrued by the given physical account is calculated by aggregating amounts of interest accrued by each of the corresponding virtual accounts.

8. The computer system of claim 1, wherein:
the interest accrual information includes an amount of interest accrued by a given physical account, and the physical account ledger is updated by posting the amount of interest accrued by the given physical account from an expense account of a financial institution to the physical account; and
the virtual account ledger is updated by posting the amount of interest accrued by the given physical account to a default virtual interest account.

9. A computer-implemented method comprising:
maintaining an account data store storing account data, the account data including mappings between physical accounts and corresponding virtual accounts, and further including, for each physical account and the corresponding virtual accounts, interest distribution parameters indicating how interest is distributed between the physical account and the corresponding virtual accounts; and
periodically, for each physical account:
querying the account data store, using an identifier of the physical account, to identify the corresponding virtual accounts;
receiving from at least one of the physical account ledger and the virtual account ledger, interest accrual information;
retrieving, from the account data store, the interest distribution parameters for the physical account and the corresponding virtual accounts;
determining, using the interest accrual information and interest distribution parameters, amounts of interest for the physical account and each virtual account corresponding to the physical account;
updating the physical account ledger to reflect the determined amount of interest for the physical account; and
updating the virtual account ledger to reflect, for each virtual account that corresponds to the physical account, the determined amount of interest for that virtual account.

10. The computer-implemented method of claim 9, wherein the virtual accounts that correspond to a given physical account include a default virtual interest account, a default virtual fee account, and a default virtual suspense account.

11. The computer-implemented method of claim 9, wherein the virtual accounts that correspond to a given physical account are arranged in a hierarchy, the hierarchy including a first plurality of virtual accounts in a first level and a second plurality of virtual accounts in a second level.

12. The computer-implemented method of claim 9, wherein:
updating the physical account ledger, for a given physical account, comprises posting an amount of interest accrued by the given physical account from an expense account of a financial institution to the physical account; and
updating the virtual account ledger comprises determining, using a predetermined allocation, amounts to distribute to each of the virtual accounts corresponding to the given physical account, and posting the determined amounts from a default virtual interest account to the virtual accounts that correspond to the physical account.

13. The computer-implemented method of claim 12, wherein the amount of interest accrued by the given physical account is calculated by aggregating amounts of interest accrued by each of the corresponding virtual accounts.

14. The computer-implemented method of claim 9, wherein:
updating the physical account ledger, for a given physical account, comprises posting an amount of interest accrued by the given physical account from an expense account of a financial institution to the physical account; and
updating the virtual account ledger comprises posting the amount of interest accrued by the given physical account to a default virtual interest account.

15. A non-transitory computer-readable medium storing instructions that, when executed by a computer system, cause the computer system to perform operation comprising:
maintaining an account data store storing account data, the account data including mappings between physical accounts and corresponding virtual accounts, and further including, for each physical account and the corresponding virtual accounts, interest distribution parameters indicating how interest is distributed between the physical account and the corresponding virtual accounts; and
periodically, for each physical account:
querying the account data store, using an identifier of the physical account, to identify the corresponding virtual accounts;
receiving from at least one of the physical account ledger and the virtual account ledger, interest accrual information;
retrieving, from the account data store, the interest distribution parameters for the physical account and the corresponding virtual accounts;
determining, using the interest accrual information and interest distribution parameters, amounts of interest for the physical account and each virtual account corresponding to the physical account;
updating the physical account ledger to reflect the determined amount of interest for the physical account; and
updating the virtual account ledger to reflect, for each virtual account that corresponds to the physical account, the determined amount of interest for that virtual account.

16. The non-transitory computer-readable medium of claim 15, wherein the virtual accounts that correspond to a given physical account include a default virtual interest account, a default virtual fee account, and a default virtual suspense account.

17. The non-transitory computer-readable medium of claim 15, wherein the virtual accounts that correspond to a given physical account are arranged in a hierarchy, the hierarchy including a first plurality of virtual accounts in a first level and a second plurality of virtual accounts in a second level.

18. The non-transitory computer-readable medium of claim 15, wherein:
updating the physical account ledger, for a given physical account, comprises posting an amount of interest accrued by the given physical account from an expense account of a financial institution to the physical account; and
updating the virtual account ledger comprises determining, using a predetermined allocation, amounts to distribute to each of the virtual accounts corresponding to the given physical account, and posting the determined amounts from a default virtual interest account to the virtual accounts that correspond to the physical account.

19. The non-transitory computer-readable medium of claim 18, wherein the amount of interest accrued by the given physical account is calculated by aggregating amounts of interest accrued by each of the corresponding virtual accounts.

20. The non-transitory computer-readable medium of claim 15, wherein:
updating the physical account ledger, for a given physical account, comprises posting an amount of interest accrued by the given physical account from an expense account of a financial institution to the physical account; and
updating the virtual account ledger comprises posting the amount of interest accrued by the given physical account to a default virtual interest account.
